(19) United States
(12) Patent Application Publication
(10) Pub. No.: US 2014/0107246 A1
(43) Pub. Date: Apr. 17, 2014

(54) ULTRAVIOLET CURED POLYESTERS FROM SUSTAINABLE MATERIALS

(71) Applicants: Michael P. Bigwood, Yukon, OK (US); Linda S. Smith, Yukon, OK (US)

(72) Inventors: Michael P. Bigwood, Yukon, OK (US); Linda S. Smith, Yukon, OK (US)

(73) Assignee: Polymer Phases, Inc., Oreland, PA (US)

(21) Appl. No.: 14/124,196

(22) PCT Filed: Jun. 6, 2012
(86) PCT No.: PCT/US12/41069

§ 371 Date: Dec. 5, 2013

Related U.S. Application Data
(60) Provisional application No. 61/494,217, filed on Jun. 7, 2011.
(60) Provisional application No. 61/568,901, filed on Dec. 9, 2011.

(51) Int. Cl. C08G 63/80

(52) U.S. Cl. CPC C08G 63/80
USPC 522/33

(57) ABSTRACT

Crosslinked, ultraviolet cured polycondensation products of either a saturated or unsaturated polyol and an unsaturated polyacid are disclosed. The preferred monomers used in the present invention are sustainable monomers, such as glycerol, castor oil, fumaric acid, sebacic acid, and citric acid. Other monomers, including maleic acid, may also be used. The monomers are cured using a photoinitiator. Processes for preparing the polycondensation products are also provided.

### CROSS REFERENCE TO RELATED APPLICATIONS

This application claims the benefit of priority to U.S. Patent App. Ser. No. 61/494,217, filed on Jun. 7, 2011, and the benefit of priority to U.S. Patent App. Ser. No. 61/568,901, filed on Dec. 9, 2011, both of which applications are hereby incorporated by reference herein in their entireties.

### FIELD OF THE INVENTION

The present invention relates to polyesters that are the polycondensation products of either a saturated or unsaturated polyol and an unsaturated polyacid that are cured by ultraviolet (“UV”) radiation, and methods of their production and use. The polyols and polyacids used in the present invention may be sustainable monomers obtained from renewable resources. Glycerol, castor oil, fumaric acid, sebacic acid, and citric acid are such sustainable monomers. The present invention also relates to said unsaturated polyesters with additional pendant olefinic groups. The polycondensation products are formed through a process involving prepolymer formation at a first temperature and then curing the prepolymer using UV radiation. The prepolymer may be stored as a liquid, a solution, a suspension, an emulsion or as a hardened polymer prior to final application and then placed into a reactor or applied to a product for final UV curing.

### BACKGROUND OF THE INVENTION

It is desirable to use sustainable monomers in polymer production to avoid the economic and environmental problems associated with monomers produced through petroleum fractionation and manufacturing. Sustainable monomers are those monomers that can be manufactured from a readily renewable resource without reliance on fossil fuels as the starting material's source. For example, the triol glycerol is readily obtained from natural oils and fats and the acid fumaric acid can be obtained from plant or microorganism synthesis sources without using fossil fuels as a starting material.

Polyesters formed from glycerol and certain polyacids have been disclosed. These applications typically involve forming the polymer and then curing the resulting polymer under vacuum. For example, US Patent Application Pub. No. 2003/0118692, published Jun. 26, 2003, discloses polycondensation of glycerol and sebacic acid at 120° C. under argon for 24 hours before the pressure was reduced from 1 Torr to 40 mTorr over five hours. The reaction mixture was kept at 40 mTorr and 120° C. for 48 hours.

US2003/0118692 also discloses that this elastomer is a thermoset polymer and that the polymer can be processed into various shapes by curing under vacuum in a mold, such as at 120° C. and 100 mTorr.

U.S. Pat. No. 5,763,099, issued Jun. 9, 1998, discloses unsaturated polyesters containing both glycerol and fumaric acid. The polyesters disclosed are used as binder compositions in binder coating applications and include materials other than glycerol and fumaric acid. Werry and Fossum, “Hyperbranching Polymerization of Glycerol and Fumaric Acid”, Polymer Preprints 2007, 48(1), 426-27 discloses highly branched unsaturated polymers made from glycerol, fumaric acid and p-toluenesulfonic acid using a single stage polymerization reaction.

Similarly, WO 2010/059925, published on May 27, 2010, discloses highly crosslinked polyesters made from a combination of glycerol, and fumaric, maleic or sebacic acids, as well as other polyols and polyacids. WO 2010/059925 requires a two stage process, however, and involves heat-curing the final polycondensation product.

For many industrial applications, such as coatings, films and adhesives, polymers that are resistant to water, other solvents, and wear are desirable. For example, polymer coatings are used on articles of furniture or other durable goods made from wood and on paper products, such as posters, films, and graphic arts. These products often have low resistance to heat such that coatings that do not require heat curing are preferable. The present invention provides a method of coating objects that are susceptible to degradation or deformation by heat or water with a polymer coating that is resistant to scratches and to water and other solvents.

The use of compositions containing maleic, fumaric, or sebacic acid as binders for UV curing is known in the art. These compositions are used in UV curable liquid coating and powder coating formulations. For example, U.S. Pat. No. 5,763,099, U.S. Pat. No. 6,136,882, EP 0618237, and WO 1996/001283 disclose compositions that involve one or more polycarboxylic monomers besides maleic, fumaric, or sebacic acid; another polymeric material, a reactive diluent, or both.

It is an object of the invention to provide polyesters produced partially or wholly from sustainable monomers for use as films and coatings having high mechanical performance. It is another object of the invention to produce binders to be used in UV cured polyesters, including films and coating formulations, without the use of a second polymeric material, and, in certain cases, without the use of a reactive diluent to increase flowability. Furthermore, it is another object to provide a process for producing such polyesters that is economical and can be performed under standard conditions with standard equipment.

### BRIEF SUMMARY

A UV cured, crosslinked polycondensation product of (a) one or more polyols selected from the group consisting of: (1) polyols with three or more hydroxyl groups, (2) acetal forms of (1), and (3) mixtures thereof, and (b) one or more polyacids selected from the group consisting of: (1) polyacids with two or more carboxylic groups, (2) anhydrides of (1), (3) esters of (1), and (4) mixtures thereof, wherein at least one of the polyacids is unsaturated; in which the molar ratio of polyol to polyacid is from about 1:3 to about 3:1; and the UV cured, crosslinked polycondensation product is highly-crosslinked, as evidenced by general insolubility in one or more solvents selected from the group consisting of: (1) water, (2) acetone, and (3) soap.

In another aspect, the invention may also be the UV cured, crosslinked polycondensation product wherein the polyol is glycerol, castor oil, or any combination thereof and the polyacid is selected from (1) maleic acid or its anhydride, (2) sebacic acid, (3) fumaric acid, (4) citric acid, (5) succinic acid, (6) anhydride forms of (1)-(5), (7) ester forms of (1)-(5), and (8) mixtures thereof; in which the molar ratio of polyol to polyacid is from about 1:3 to about 3:1; and the UV cured, crosslinked polycondensation product is highly-crosslinked, as evidenced by general insolubility in one or more solvents selected from the group consisting of: (1) water, (2) acetone, and (3) soap.

In another aspect, the invention may also be the UV cured, crosslinked polycondensation product wherein the polyol is glycerol, castor oil, or any combination thereof, and the polyacid is selected from (1) maleic acid, (2) sebacic acid, (3) fumaric acid, (4) citric acid, (5) succinic acid, (6) anhydride forms of (1)-(5), (7) ester forms of (1)-(5), and (8) mixtures thereof; in which the molar ratio of polyol to polyacid is from about 1:3 to about 3:1, and a pendant double bond is subsequently included in the polycondensation product through reaction, for example using acryloyl chloride, methacryloyl chloride, glycidyl methacrylate, glycidyl acrylate, methacrylic acid, or acrylic acid; and the UV cured, crosslinked polycondensation product is highly-crosslinked, as evidenced by general insolubility in one or more solvents selected from the group consisting of: (1) water, (2) acetone, and (3) soap.

The present invention also provides a method for preparing a UV cured, crosslinked polycondensation product comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated, (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture: (d) optionally mixing the second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof, to form a third mixture; (e) curing either (1) the second mixture or (2) the third mixture using ultraviolet radiation under conditions sufficient to produce a highly crosslinked polycondensation product.

In another aspect, the invention provides a method of preparing a UV cured, crosslinked polycondensation product comprising: (a) mixing glycerol, castor oil, or any combination thereof with one or more polyacids selected from the group consisting of: (1) fumaric acid, (2) maleic acid or its anhydride, (3) sebacic acid, (4) citric acid, and (5) mixtures thereof, wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture; (d) optionally mixing the second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof, to form a third mixture; (e) curing either (1) the second mixture or (2) the third mixture using ultraviolet radiation under conditions sufficient to produce a highly crosslinked polycondensation product.

In another aspect, the invention provides a method of preparing a UV cured, crosslinked film or coating comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated: (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture; (d) cooling the resulting second mixture to ambient conditions; (e) heating the cooled second mixture to a temperature above the gel point of the second mixture until the second mixture is flowable; (f) optionally mixing the flowable second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof to form a polymer mixture; and (g) applying either (1) the flowable second mixture or (2) the polymer mixture to a surface and curing by using ultraviolet radiation under conditions sufficient to produce a highly crosslinked film or coating.

In yet another aspect, the invention provides a method of preparing a UV cured, crosslinked film or coating comprising: (a) mixing glycerol, castor oil, or any combination thereof with one or more polyacids selected from the group consisting of: (1) fumaric acid, (2) maleic acid or its anhydride, (3) sebacic acid, (4) citric acid and (5) mixtures thereof, wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture; (d) cooling the resulting second mixture to ambient conditions; (e) heating the cooled second mixture to a temperature above the gel point of the second mixture until the second mixture is flowable; (f) optionally mixing the flowable second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof to form a polymer mixture; and (g) applying either (1) the flowable second mixture or (2) the polymer mixture to a surface and curing by using ultraviolet radiation under conditions sufficient to produce a highly crosslinked film or coating.

In yet another aspect, the invention is a method of preparing a stabilized small prepolymer form comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated; (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer, (c) mixing the flowable low molecular weight prepolymer with a photoinitiator to form a second mixture; and (d) processing the second mixture into a form that is small and may easily be moved by a pneumatic or other transport system and (e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form.

In another aspect, the invention is a method of preparing a stabilized small prepolymer form comprising: (a) mixing glycerol, castor oil, or any combination thereof with one or more polyacids selected from the group consisting of: (1) fumaric acid, (2) maleic acid or its anhydride, (3) sebacic acid, (4) citric acid and (5) mixtures thereof, wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture; (d) processing the second mixture into a small prepolymer form that is small and may easily be moved by a pneumatic or other transport system; and (e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form.

Another aspect of the invention is a method for preparing a UV cured, crosslinked polycondensation product comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated; (b) reacting the first mixture at a pressure at or above about one (1) atmosphere and at a temperature from about 80° C. to about 250° C. for a period of time from about fifteen (15) minutes to about three hundred (300) minutes to form a flowable low molecular weight prepolymer; (c) mixing the flowable low molecular weight prepolymer with a photoinitiator to form a second mixture; (d) processing the second mixture into a small prepolymer form that is small and may easily be moved by a pneumatic or other transport system; (e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form; (f) cooling the stabilized small prepolymer form to ambient conditions; (g) heating the stabilized small prepolymer form so that it flowable; (h) optionally mixing the flowable stabilized small prepolymer form with a modification compound selected from the group consisting of: (1) polymer additives, (2) plasticizers, (3) foam blowing agents, (4) diluents, and (5) mixtures thereof, to form a third mixture; (i) curing either (1) flowable stabilized small prepolymer form or (2) the third mixture either by (1) using ultraviolet radiation under conditions sufficient to produce a highly crosslinked polycondensation product, or by (2) heating at a pressure at or above about one (1) atmosphere and at a temperature from about 175° C. to about 400° C. for a period of time from about three (3) seconds to about sixty (60) minutes to form a highly crosslinked polycondensation product.

In another aspect, the invention is a method for preparing a UV cured, crosslinked film or coating comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated; (b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer, (c) mixing the flowable low molecular weight prepolymer with a photoinitiator to form a second mixture; (d) processing the second mixture into a small prepolymer form that is small and may easily be moved by a pneumatic or other transport system: (e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form; (f) cooling the stabilized small prepolymer form to ambient conditions; (g) heating the stabilized small prepolymer form so that it flowable; (h) optionally mixing the flowable stabilized small prepolymer form with a modification compound selected from the group consisting of: (1) polymer additives, (2) plasticizers, (3) foam blowing agents, (4) diluents, and (5) mixtures thereof to form a polymer mixture; and (i) applying either (1) the flowable stabilized small prepolymer form or (2) the polymer mixture to a surface and curing either by (1) using ultraviolet radiation under conditions sufficient to produce a highly crosslinked film or coating, or by (2) heating at a pressure at or above about one (1) atmosphere and at a temperature from about 175° C. to about 400° C. for a period of time from about three (3) seconds to about sixty (60) minutes to form a highly crosslinked film or coating.

### DETAILED DESCRIPTION OF PREFERRED EMBODIMENTS

As used herein, the singular terms “a” and “the” are synonymous and used interchangeably with “one or more” or “at least one” unless the context clearly indicates a contrary meaning. For all the compositions and processes included herein, it should be understood that there will be at least trace amounts of the unreacted constituent components, including any monomers and polymer reaction catalysts used. Unless otherwise indicated, all percentages are weight percentages and all ratios are molar ratios. As used herein with respect to UV curing, the term “pass” refers to a one full pass over the entire surface area of the low molecular weight prepolymer to be cured using UV radiation at a specified radiation rate.

The term “polyol” refers to any molecule with two or more hydroxyl groups, including acetal forms of these molecules. The term “polyacid” refers to any carboxylic acid bearing two or more carboxylic groups, including anhydride and ester forms of these molecules. The term “prepolymer” refers to the polymer created after the initial heating step of the invention and the terms “final polymer,” “cured polymer,” “UV cured, crosslinked polycondensation product,” or “UV cured, crosslinked film or coating” refer to the crosslinked polymer created by polycondensation followed by curing with UV radiation. The term “general insolubility” means that a substance has not begun to dissolve when exposed to the solvent after at least 15 minutes at room temperature and pressure.

In certain embodiments, the molar ratio of polyacid to polyol is between a range selected from the group consisting of 1:3 and 3:1; 1:2 and 2:1; 1.25:3 and 3:1.25; 1.5:3 and 3:1.5; 1.75:3 and 3:1.75; 2:3 and 3:2; 2.25:3 and 3:2.25; 2.5:3 and 3:2.5; 2.75:3 and 3:2.75; 1:2.75 and 2.75:1; 1.25:2.75 and 2.75:1.25; 1.5:2.75 and 2.75:1.5; 1.75:2.75 and 2.75:1.75; 2:2.75 and 2.75:2; 2.25:2.75 and 2.75:2.25; 2.5:2.75 and 2.75:2.5; 1:2.5 and 2.5:1; 1:2.25 and 2.25:1; 1:1.75 and 1.75:1; 1:1.5 and 1.5:1; 1:1.25 and 1.25:1:1.25:2.5 and 2.5:1.25; 1.5:2.5 and 2.5:1.5; 1.75:2.5 and 2.5:1.75; 2:2.5 and 2.5:2; 2.25:2.5 and 2.5:2.25; 1.25:2.25 and 2.25:1.25; 1.5:2.25 and 2.25:1.5; 1.75:2.25 and 2.25:1.75; 2:2.25 and 2.25:2; 1.25:2 and 2:1.25; 1.5:2 and 2:1.5; and about 1:1.

Preferably, the polyacid is maleic, fumaric, sebacic, and/or citric acid and/or maleic anhydride and the polyol is glycerol, castor oil, or any combination thereof. In certain embodiments, the molar ratio of maleic acid or anhydride, fumaric acid and/or sebacic acid to glycerol, castor oil, or any combination thereof in the final polymer or used in the manufacturing processes of the invention is one of the ratios identified above. Preferably the polyacid is maleic acid, maleic anhydride or fumaric acid and the polyol is glycerol and, in some embodiments, these preferred monomers are combined in the final product or used in the manufacturing processes of the invention in one of the molar ratios provided above. In some embodiments, the final polymer consists essentially of polymerized maleic acid or its anhydride and glycerol, or of polymerized fumaric acid and glycerol, or of polymerized maleic acid or maleic anhydride, glycerol and sebacic acid, or of polymerized fumaric acid, glycerol and sebacic acid, or of polymerized maleic acid or maleic anhydride, fumaric acid, sebacic acid and glycerol. In other embodiments, the final polymer consists essentially of polymerized maleic acid or its anhydride, fumaric acid and glycerol; or fumaric acid, citric acid and glycerol; or maleic acid or its anhydride, citric acid, and glycerol.

In some embodiments, the final polymer of the manufacturing process of the invention includes maleic acid, maleic anhydride or fumaric acid as the only polyacid monomer; in one embodiment only maleic acid or its anhydride as the sole polyacid monomer; in one embodiment only fumaric acid as the only polyacid monomer; in one embodiment only maleic acid or maleic anhydride and sebacic acid are the only polyacid monomers; in one embodiment only maleic acid or maleic anhydride and citric acids are the only polyacid monomers; in one embodiment only fumaric and citric acid are the only polyacid monomers; and in one embodiment only fumaric and sebacic acids are the only polyacid monomers. In certain embodiments, the monomers are selected from only maleic acid, maleic anhydride, citric acid, sebacic acid, fumaric acid, succinic acid and glycerol, optionally at one of the ratios provided above, and no other polymeric material or reactive diluent is used in the final polymer or in the manufacturing process of the invention.

In some embodiments there is less than 0.01%, 0.1%, 1.0%, 1.5%, 2.0%, 3%, 4%, 5%, 6%, 7%, 8%, 9%, 10.0%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% of a polyacid monomer present in the manufacturing process or in the final polymer that is not maleic acid, maleic anhydride or fumaric acid. In some embodiments, by weight of the final polymer, there is less than 0.01%, 0.1%, 1.0%, 1.5%, 2.0%, 3%, 4%, 5%, 6%, 7%, 8%, 9%, 10.0%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% of a polymeric component that is not glycerol, maleic acid, maleic anhydride, fumaric acid or sebacic acid in the final polymer.

Compositions and processes in accordance with the various embodiments of the present invention are suitable for use in making a wide array of coatings, films, and articles of manufacture that require resistance to water and other solvents and scratching or denting. The present invention includes a UV cured polyester that is highly crosslinked and that exhibits resistance to one or more solvents, including water and other solvents. Solubility may be controlled by various means, including, but not limited to, varying the polymerization in the prepolymer and by the monomers used to form the prepolymer. It is often desirable to manipulate the final product's solubility based on the requirements of the final application. For example, for a UV cured polyester used as a fingernail polish, it is desirable for the UV cured polyester to have good solvent resistance to water and soapy water, but poor or no solvent resistance to acetone. When used in wood coating, inks, foam films, and graphic arts applications, it is desirable for the final UV cured polyester to have a glossy appearance, with good scratch resistance and good solvent resistance to water, acetone, soapy water and ethanol. When used in food packaging applications (including coatings), it is desirable for the final UV cured polyester to be essentially clear with good solvent resistance. Also included in the present invention is a method of making the UV cured, crosslinked polymers and a method of forming coatings, films, and articles of manufacture using the cured highly crosslinked polymers.

The UV cured highly crosslinked polyesters of the present invention do not require special processing conditions to remove water generated during the formation reaction (such as being conducted under vacuum pressure) and react at lower temperatures than those known in the art. These stable, cured, high molecular weight, highly crosslinked polyesters can be prepared by a step-wise reaction method. The method comprises two steps. In the first step, low molecular weight polyester prepolymers are synthesized by (i) reacting one or more polyols, or acetals of these polyols, with one or more polyacids, or anhydrides or esters of these polyacids, wherein at least one polyacid is unsaturated, at a pressure at or above about one (1) atmosphere and at a temperature from about 80° C. to about 250° C. for a time from about fifteen (15) minutes to about three hundred (300) minutes.

If the polymerization reaction forms water as a byproduct, it is preferred that the reaction temperature be above about 100° C. to allow the water to evaporate. Preferably, the reaction occurs at a temperature range from about 110° C. to about 250° C. This first step of the reaction may occur at a temperature range from about 110° C. to about 150° C., about 120° C. to about 140° C., about 130° C. to about 180° C., about 140° C. to about 170° C., about 130° C. to about 160° C., about 140° C. to about 160° C., about 140° C. to about 190° C., about 130° C. to about 180° C., about 150° C. to about 200° C., about 160° C. to about 200° C., about 170° C. to about 200° C., about 180° C. to about 200° C., about 190° C. to about 220° C., about 200° C. to about 230° C., about 210° C. to about 240° C., or about 160° C. to about 240° C. When the polyacid is a triacid, the preferred temperatures are lower than when the polyacid is a diacid.

Before the partial or final UV curing step, a photoinitiator is added to the low molecular weight prepolymer. Photoinitiators known in the art include, but are not limited to, benzoin and its ethers, benzyl ketals such as 2,2-dimethoxy-2-phenyl acetophenone (ADDITOL BDK), acyl phosphines such as diphenyl(2,4,6-trimethylbenzoyl)phosphine oxide (ADDITOL TPO), aryl ketones such as 2-hydroxy-2-methyl-1-phenyl propanone (DAROCURE 1173) or Michler's ketone. One such photoinitiator is DAROCURE 1173. The photoinitiator catalyzes the crosslinking reaction in the presence of UV radiation. The foregoing lists are meant to be illustrative only and are not meant to exclude any suitable photoinitiators. Those skilled in the art of photochemistry are fully aware that photoactivators can be used in combination with the aforementioned photoinitiators and that synergistic effects are sometimes achieved when such combinations are used. Photoactivators are well known in the art and require no further description to make known what they are and the concentrations at which they are effective. Nonetheless, one can mention as illustrative of suitable photoactivators, methylamine, tributylamine, methyldiethanolamine, 2-aminoethylethanolamine, allylamine, cyclohexylamine, cyclopentadienylamine, diphenylamine, ditolylamine, trixylylamine, tribenzylamine, n-cyclohexylethyleneimine, piperidine, N-methylpiperazine, 2,2-dimethyl-1,3-bis(3-N-morpholinyl)-propionyloxypropane, and mixtures thereof. The photoinitiator is added as a weight percent of the total mass of the UV curable material in the formulations in a range from about 0.1% to about 20%. In certain embodiments, the photoinitiator may comprise from about 0.1% to about 10%, about 0.1% to about 5%, about 1% to about 10%, about 5% to about 20%, about 1% to about 15%, about 10% to about 20%, or about 5% to about 15% by weight of (1) the total mass of the unsaturated, UV curable monomer or monomer(s) present in the formulations, or (2) the total mass of the unsaturated, UV curable polyacid.

After the first step, the resultant low molecular weight polyester prepolymer may optionally be cooled such that it forms a solid. In one embodiment, the cooled solid is or is further processed to be a pellet, powder or some other form that is small and may easily be moved in a pneumatic transportation system, referred to herein collectively as “small prepolymer form.” The small prepolymer form may optionally be stabilized in a partial curing step that affects substantially only the surface of the pellet or powder to reduce tackiness or water absorption that may interfere with transport or storage. This resulting partially cured form is referred to herein as “stabilized small prepolymer form.” This partial curing step is performed by curing the surface of the form by applying ultraviolet radiation under conditions sufficient to produce crosslinking on the surface of the form without complete crosslinking, such as by exposure to a low dose of UV radiation. This optional partial curing step may be carried out before or after the low molecular weight polyester is formed into its small prepolymer form. In one embodiment, the partial curing step is completed before forming the small prepolymer form, and the polymer is exposed to UV radiation while it is in, or as it is leaving, the polymer processing equipment that forms the small prepolymer form, such as UV exposure on a conveyer between the extruder and a flywheel or other forming device.

During the step of forming a stabilized small prepolymer form by UV curing, the polymer is exposed to UV radiation under conditions readily able to be determined by one of ordinary skill in the art to create surface crosslinking. For example, such conditions may be for a period in a range from about 1 second to about 10 minutes and an exposure distance between the UV source and the prepolymer from about 1 centimeter to about 50 centimeters. Exposure is accomplished either by (1) passing the UV radiation source over the polymer at a fixed distance and speed for a certain number of passes, or (2) passing the polymer under the UV radiation source at a fixed distance and speed for a certain number of passes. In certain embodiments of the invention, the number of passes may be between 1 and 10 passes, 2 and 5 passes, 5 and 10 passes, 4 and 8 passes, or 2 and 6 passes. If the prepolymer is pelletized or ground before the curing step, the low molecular weight prepolymer must be heated to make it flowable for applications involving coatings and film.

Also before the UV curing step, one or more polymer modification agents may be added to the low molecular weight prepolymer. These include (1) polymer additives, (2) plasticizers, (3) foam blowing agents, (4) diluents, (5) other polymeric materials, (6) radically polymerizable monomers, and (7) mixtures thereof. Diluents are low viscosity, low molecular weight additives that increase the flowability of the prepolymer and are useful for coating and film applications. The viscosity of the polyester formulation can also be controlled through the formation of organic or aqueous solutions, aqueous suspensions or oil-in-water or water-in-oil emulsions.

If the low molecular weight polyester prepolymer is made into a stabilized small prepolymer form, this stabilized small prepolymer form may be further processed into a highly crosslinked final polymer by heating the stabilized small prepolymer form until it is flowable and further curing the flowable previously stabilized prepolymer by heating or by exposure to UV radiation. When heat curing is used, the flowable previously stabilized prepolymer is further reacted to form a final cured polymer that has a high molecular weight and is highly crosslinked. Before heat curing, the flowable previously stabilized prepolymer may be mixed with one or more polymer modification compounds, including, but not limited to, polymer additives, plasticizers, and foam blowing agents. The flowable previously stabilized prepolymer is then cured in a further reaction step at a pressure at or above about one (1) atmosphere and a temperature from about 175° C. to about 400° C. for a period of time from about three (3) seconds to about sixty (60) minutes. In certain embodiments, this curing step occurs at a pressure at or above about one (1) atmosphere and a temperature from about 175° C. to about 300° C., about 190° C. to about 300° C., about 190° C. to about 200° C., about 200° C. to about 300° C., about 250° C. to about 300° C., about 175° C. to about 250° C., about 175° C. to about 220° C., about 200° C. to about 400° C., about 250° C. to about 400° C., or about 300° C. to about 400° C. for a period of time from about five (5) seconds to about sixty (60) minutes, about thirty (30) seconds to about sixty (60) minutes, about five (5) minutes to about sixty (60) minutes, about twenty (20) minutes to about sixty (60) minutes, about forty (40) minutes to about sixty (60) minutes, about five (5) seconds to about thirty (30) minutes, about two (2) minutes to about thirty (30) minutes, about five (5) minutes to about thirty (30) minutes, about three (3) seconds to about forty-five (45) minutes, about fifteen (15) minutes, about fifteen (15) minutes to about sixty (60) minutes, about twenty (20) minutes to about forty-five (45) minutes, about fifteen (15) minutes to about forty-five (45) minutes, about twenty (20) minutes to about thirty (30) minutes, or about five (5) minutes to about forty-five (45) minutes. Alternatively, the flowable previously stabilized prepolymer may be cured by exposure to UV radiation as described below.

The flowable previously stabilized prepolymer or the second mixture is cured into a highly crosslinked polyester by exposure to UV radiation. The prepolymer is exposed to UV radiation under conditions sufficient to produce a highly crosslinked product. One of skill in the art is able to determine UV radiations conditions to ensure crosslinking. Such conditions include the time of exposure, which may be for example for a period in a range from about 1 second to about 10 minutes, the exposure distance, which may be from about 1 centimeter to about 50 centimeters between the UV source and the polymer, and the strength of the UV source, such as 100 W, 400 W, 1000 W and 2000 W. The overall amount of UV radiation administered during curing can be measured by the intensity of the exposure (as measured in mW/square cm), the irradiation energy per unit area and the total photon quantity to reach the surface (mJ/square cm). Exposure is accomplished either by (1) passing the UV radiation source over the polymer at a fixed distance and speed for a certain number of passes, or (2) passing the polymer under the UV radiation source at a fixed distance and speed for a certain number of passes. In certain embodiments of the invention, the number of passes may be between 1 and 10 passes, 2 and 5 passes, 5 and 10 passes, 4 and 8 passes, or 2 and 6 passes. The UV source emits electromagnetic waves of 100 to 380 nm wavelength and is classified into three categories based on wavelength, any of which can be used as can be determined by one of skill in the art as best suited for the particular polymer and photoinitiator: UV-A (315-380 nm); UV-B (280-315 nm) and UV-C (100-280 nm).

In certain embodiments, the time period may be between from about 1 second to about 1 minute, from about 30 seconds to about 5 minutes, from about 10 seconds to about 2 minutes, from about 2 minutes to about 8 minutes, from about 5 minutes to about 10 minutes, from about 5 minutes to about 15 minutes, from about 1 minute to about 4 minutes, from about 1 minute to about 3 minutes. Any of the foregoing time periods may be used with a 100 W, 200 W, 400 W, 1000 W, or 2000 W UV source, a UV source having a power range from about 10 W to about 2000 W, or any other UV source known to one of skill in the art for curing polymers.

In certain embodiments, the distance of the prepolymer to the radiation source may be from about 1 cm to about 15 cm, from about 5 cm to about 25 cm, from about 10 cm to about 30 cm, from about 15 cm to about 40 cm, from about 25 cm to about 50 cm, from about 20 cm to about 40 cm, from about 10 cm to about 30 cm.

The resulting UV cured polycondensation product is highly crosslinked, as may be evidenced by general insolubility and resistance to one or more solvents, including, but not limited to, water, acetone, soap, and ethanol. General insolubility in a solvent may be demonstrated by generally accepted methods. One method is to immerse a sample of a substance into the solvent and observe the material over time to determine if it dissolves. Another method is to place the solvent into direct contact with the substance and observe it over time to determine if the solvent adversely affects the substance. This method is preferred for films, laminates, and other coatings.

A film or coating according to the invention is prepared by applying the flowable prepolymer to a surface or a substrate, such as by spraying, rolling, knife-coating, pouring, brushing, or dipping. Any solvent present may be flashed off with application of heat. The coated substrate is then subjected to UV radiation. Substrates may be selected from the group consisting of wood, metal, plastic (including polymer films), paper, leather, textiles, felt, finger or toe nails, glass or mineral substrates. The applied film thicknesses (prior to curing) are typically between 0.5 and 5000 microns, between 5 and 1500 microns, or between 15 and 1000 microns.

The properties of the prepolymer, and thus the cured polymer, may be manipulated by varying the molar ratio of polyol to polyacid. In the present invention, the polyol:polyacid molar ratio may range from about 1:3 to about 3:1. To achieve the highest potential for crosslinking in the cured polymer, the initial polyol:polyacid molar ratio is about 1:1. If a more flowable prepolymer is desired, the polyol:polyacid molar ratio is increased to a range from about 1:1 to about 3:1. If a harder (less flowable) prepolymer is desired, the polyol:polyacid molar ratio may be decreased to a range from about 1:1 to about 1:3. In other embodiments, the molar ratio of polyol:polyacid is about 1:2 to about 2:1; or about 1:1.5 to about 1.5:1.

For purposes of the invention, the polyol may be any saturated or unsaturated molecule with three or more hydroxyl groups, including, but not limited to linear or cyclic (C₁-C₆) trihydroxy alkanes, linear or cyclic (C₁-C₆) trihydroxy alkenes, including the acetal forms of these molecules. Preferably, the polyol is one or more of the following: glycerol, isopropylidene glycerol (solketal), castor oil, pentaerythritol, 1,2,4-bunatetriol, and their acetal forms. For purposes of the present invention, naturally occurring, sustainable polyols are preferred, including, but not limited to, glycerol.

The polyacid may be any molecule with two or more carboxylic groups, including, but not limited to, linear dicarboxylic acids where the acid groups are separated by an aliphatic chain of variable length (for example, succinic, adipic, and sebacic acids), unsaturated hydrocarbon chains of various lengths (for example, fumaric acid), dicarboxylic acids containing a saturated or aromatic ring (for example, phthalic and terephthalic acids), and linear or cyclic, aliphatic or unsaturated tricarboxylic acids (for example, citric and trimellitic acids), and anhydrides and esters of these carboxylic acids. For purposes of the present invention, naturally occurring, sustainable polyacids are preferred. In certain embodiments, the polyacid is maleic acid, fumaric acid, citric acid, or sebacic acid, or mixtures thereof. Sebacic acid is preferred when the final polymer needs to exhibit increased toughness, particularly in film applications.

For purposes of the present invention, there must be some degree of unsaturation in the prepolymer. Either the polyol or the polyacid may be unsaturated. Preferably, the polyacid provides the degree of unsaturation to the polyol.

In one embodiment, the polyol is glycerol or its acetal and the polyacid is fumaric acid or its esters. Both glycerol and fumaric acid are non-toxic, sustainable starting materials; thus, prepolymers and UV cured polymers resulting from glycerol and fumaric acid have the advantage of being produced from sustainable materials.

Although the final UV curing step to create a highly crosslinked, UV cured polymer of the present invention does not necessarily require foam blowing agents to form a foamed cured polymer, blowing agents may be used. These blowing agents, include, but are not limited to, carbon dioxide, water vapor, carbonate salts, isocyanate, gaseous hydrocarbons, halogenated hydrocarbons, and alcohols. When water is used as a blowing agent, the resulting cured polymer foam exhibits a low density. In certain embodiments, the foam blowing agents do not include porogens, such as sodium chloride.

In addition to foam blowing agents, plasticizers, including, but not limited to linear (C₁-C₆) or cyclic (C₃-C₆) aliphatic mono- or di-ethers of ethylene glycol or glycerol, and cosolvents, including, but not limited to, diethylene glycol monobutyl ether, ethylene glycol monobutyl ether, propylene glycol monobutyl ether, and 2,2,4-trimethyl-1,3,-pentane diol monoisobutylate, may be added to the prepolymers before curing into the final polymer. Plasticizers result in a more flexible cured polymer or cured polymer foam, while cosolvents are useful in producing clear cured polymer coatings. In addition to plasticizers, in another embodiment, sebacic acid is used in addition to a first polyacid. The addition of the sebacic acid will also result in a more flexible final cured polymer, with flexibility generally increasing with the concentration of sebacic acid.

When isocyanate is used with a glycerol-based prepolymer, a polyurethane foam is formed under ambient conditions. The isocyanate-catalyzed polyurethane cured polymer foam increases in rigidity as the concentration of isocyanate is increased. Additionally, the isocyanate-catalyzed polyurethane cured polymer may be used as an adhesive or coating by curing at temperatures from about 130° C. to about 250° C.; and preferably from about 140° C. to about 160° C. when used on metals.

### EXAMPLES

The following nonlimiting Examples help to illustrate embodiments of the present invention.

For each of the following examples, the following definitions apply: percentages are weight percents (wt %); ratios are molar ratios. The following units are used, unless otherwise noted: grams (g); milliliters (mL); minutes (min); hours (hr): and degrees Celsius (° C.).

For each of the following examples, the prepolymer was cured using UV radiation from a Dr. Hönle UVA Hand 250 CUL lamp (available from Honle UV America Inc.).

For each of the following examples describing resistance to a solvent, the resistance was measured after a specified time and ranked on a scale of 1-5, with 1 indicating no resistance to the solvent and 5 representing good resistance to the solvent.

### Example 1

### Preparation of a UV Cured Glycerol/Fumaric Acid/Sebacic Acid Film

Samples of a glycerol/fumaric acid/sebacic acid prepolymer were prepared by the following method. 31 g of glycerol, 45 g of fumaric acid and 17 g of sebacic acid were placed in a 600 mL beaker. The beaker was immersed in a 200° C. oil bath while stirring the reaction mixture at 70 RPM with a 6 cm, football shaped, perforated metal agitator blade. After 10 min, the oil bath temperature was reduced to 160° C. and stirring continued for an additional 50 minutes. Conversion of —OH groups, as measured by weight loss of water, was 33%.

Six (6) g of the resulting prepolymer were mixed with a 10% glycerol/acrylate/methacrylate reactive diluent and 1.3 g acetone (for use as a solvent). The photoinitiator compound, DAROCURE 1173, was added on a 10% solids basis. The resulting mixture exhibited a flat appearance. The mixture was rolled on to a flat, black glass-surface using a #15 wire wound rod for curing and was cured using UV radiation. The radiation source was located 5 centimeters from the final product and the mixture was cured for 3 minutes. The resulting film was dry to touch after 1 minute and fully cured after 3 minutes. After curing, the UV polymer had a clouded appearance, but exhibited good resistance to water, acetone and soap.

### Example 2

### Preparation of UV Cured Glycerol/Fumaric Acid/Sebacic Acid Coatings with Varied Concentrations of Glycerol/Acrylate/Methacrylate Diluent

Three samples of prepolymer as prepared in Example 1 were mixed with varying amounts of glycerol/acrylate/methacrylate reactive diluent and acetone as a solvent, as indicated in Table 1 (percentages are weight percent based on the prepolymer). Each sample was mixed with DAROCURE 1173 on a 10% solids basis. The mixture was rolled on to a flat, black glass-surface using a #15 wire wound rod for curing and was cured using UV radiation. Before UV curing, the three samples exhibited a flat appearance. The radiation source was located 5 cm from the final product and the mixture was cured for 3 minutes. The resulting film was dry to touch after 1 minute and fully cured after 3 minutes. After curing, all three samples exhibited a hazy, flat appearance, but the 10% and 66% diluent samples were more brittle than the 33% sample. Results of resistance to acetone, water, and soap are summarized in Table 1, below.

TABLE 1
Glycerol/Fumaric Acid/Sebacic Acid Film Polymers with Varied Diluent Conentrations

| Diluent | | Acetone | Acetone | Water | Water | Soap | Soap |
|---|---|---|---|---|---|---|---|
| Concentration | Solvent | Resistance | Resistance | Resistance | Resistance | Resistance | Resistance |
| (%) | (acetone) | (15 min) | (15 min) | (1 hour) | (24 hours) | (1 hour) | (24 hours) |
| 10 | 22% | 4 | 4 | 5 | 3 | 5 | 3 |
| 33 | 20% | 4 | 4 | 3 | 3 | 4 | 3 |
| 66 | 18% | 4 | 1 | 4 | 1 | 3 | 1 |

### Example 3

### Preparation of UV Cured Glycerol/Fumaric Acid/Sebacic Acid Coatings with Varied Concentrations of SR-454 Diluent

Three samples of the prepolymer as prepared in Example 1 were mixed with varying amounts of SR-454 reactive diluent and acetone as a solvent. The first sample was mixed with 10% SR-454 and 2.7 g acetone; the second sample was mixed with 33% SR-454 and 1.7 g acetone; the third sample was mixed with 66% SR-454 and 1.0 g acetone. Each sample was mixed with DAROCURE 1173 on a 10% solids basis. The mixture was rolled on to a flat, black glass-surface using a #15 wire wound rod for curing and was cured using UV radiation. Before UV curing, the three samples exhibited a flat appearance. The radiation source was located 5 cm from the final product and the mixture was cured for 3 minutes. The resulting film was dry to touch after 1 minute and fully cured after 3 minutes. After curing, all three samples exhibited a glossy appearance. The polymer films made using 10% and 33% SR-454 were clear, while the polymer film made using 66%/SR-454 was hazy. Results of resistance to acetone and water are summarized in Table 2, below.

TABLE 2
Glycerol/Fumaric Acid/Sebacic Acid Film Polymers
with Varied Diluent Conentrations

| | Solvent | | | | |
|---|---|---|---|---|---|
| Diluent | (acetone) | Acetone | Acetone | Water | Water |
| Concen- | concen- | Resistance | Resistance | Resistance | Resistance |
| tration | tration | (15 min) | (15 min) | (1 hour) | (24 hours) |
| 10% | 43% | 4 | 4 | 4 | 4 |
| 33% | 27.9% | 1 | 1 | 4 | 4 |
| 66% | 15.9 | 4 | 4 | 4 | 4 |

### Example 4

### Preparation of UV Cured Glycerol/Maleic Acid Films with Varied Conversion Rates

Samples of a glycerol/maleic acid prepolymer were prepared by the following method. 31 g. of glycerol, 45 g. of fumaric acid and 17 g of sebacic acid were placed in a 600 mL beaker. The beaker was immersed in an oil bath while stirring the reaction mixture, and submitted to the temperature profiles disclosed in Table 3.

TABLE 3
Temperature Profiles For Prepolymer Reaction

| | First Tempeture | First Tempeture |
|---|---|---|
| —OH | and Reaction | and Reaction |
| Conversion (%) | Time (° C./Min) | Time (° C./Min) |
| 33 | 200/10 | 160/50 |
| 55 | | |
| 76 | 200/20 | 160/40 |
| 82 | 200/20 | 200/40 |

The samples evidenced varied conversion rates from 33% to 82% conversion as disclosed in Table 4. The samples were mixed with various amounts of water as a solvent and 10% DAROCURE 1173 on a solids basis. The various samples were rolled on to a flat, black glass-surface using a #15 wire wound rod for curing and were cured using UV radiation. Before UV curing, the three samples were clear. The radiation source was located 5 centimeters from the final product and the mixture was cured for 3 minutes. Information regarding curing time and toughness are disclosed in Table 3.

TABLE 4
Glycerol/Maleic Acid Film Polymer with Varied Conversion Rates

| Conver- | | Min. UV | Min. UV | | |
|---|---|---|---|---|---|
| sion | | Cure | Cure | | Toughness/ |
| of OH | Water | for Dry- | for Full | Appearance | Brittleness |
| groups | (wt %) | to-touch | Cure | after Cure | After Cure |
| 33% | 22 | 3 | 5 | Flat, not | Brittle, easy |
| | | | | clear, a | to scratch, |
| | | | | little blue | rough, sticky |
| 55% | 20 | 3 | 5 | Gloss, clear, | Brittle, easy |
| | | | | fish eyes | to scratch, |
| | | | | | sticky |
| 76% | 23.5 | 3 | 5 | Gloss, clear, | Brittle, easy |
| | | | | little blue | to scratch, |
| | | | | | less sticky |
| | | | | | than 55% conv. |
| 82% | 32 | 1 | 3 | Gloss, clear, | Little |
| | | | | tiny fish | brittleness, |
| | | | | eyes | not easy |
| | | | | | to scratch |

### Example 5

### Glycerol/Maleic Acid Prepolymer with No Diluent

A sample of glycerol/maleic acid prepolymer was prepared by the following method. 30.7 g. of glycerol and 58 g of maleic acid were placed in a 600 mL beaker. The beaker was immersed in a 200° C. oil bath for 45 min, while stirring the reaction mixture at 70 RPM using a 6 cm, football shaped, perforated metal agitator blade. The sample was mixed with 20% acetone, 10% DAROCURE 1173 and 2% TEGO 410. The mixture was rolled on to a Leneta chart using a #15 wire wound rod for curing and was cured using UV radiation. The radiation source was located 5 centimeters from the final product and the mixture was cured for 3 minutes. The resulting film was dry to touch after 1 minute and fully cured after 3 minutes. After UV curing, the polymer film had a glossy appearance, good scratch resistance and exhibited good resistance to water, acetone, soapy water and ethanol as shown in TABLE 5.

TABLE 5
Solvent Resistance of Final Cured Polymer

| Acetone | | Water | | Soap | | Ethanol | |
|---|---|---|---|---|---|---|---|
| 1 hr | 26 hrs | 1 hr | 26 hrs | 1 hr | 26 hrs | 1 hr | 26 hrs |
| 4++ | 3 | 5 | 5 | 5 | 5 | 4++ | 4++ |

### Example 6

### UV Cure of a Glycerol/Maleic Acid/Fumaric Acid Prepolymer with No Diluent

Samples of a glycerol/maleic/acid/fumaric acid prepolymer were prepared by the following method. 30.9 g. of glycerol, 49.4 g. maleic acid and 8.73 g of fumaric acid were placed in a 600 mL beaker. The beaker was immersed in a 200° C. oil bath while stirring the reaction mixture at 70 RPM using a 6 cm, football shaped, perforated metal agitator blade for 15 min (Sample A) and 45 min (Sample B). The samples were mixed with 20% acetone (Sample A) and 35% acetone (Sample B), 10% DAROCURE 1173 and 2% TEGO 410. The mixture was rolled on to a Leneta chart using a #15 wire wound rod for curing and was cured using UV radiation. The radiation source was located 5 centimeters from the final product and the mixture was cured for 3 minutes. The resulting film was dry to touch after 1 minute and fully cured after 3 minutes. After UV curing, the polymer film had a glossy appearance, good scratch resistance and, at low reaction time (sample A), exhibited good resistance to water, acetone, soapy water, and ethanol. Sample B failed after the 26 hours spot test by cracking. The results are described in TABLE 6, below.

TABLE 6
Solvent Resistance of Final Cured Polymer

| | Acetone | | Water | | Soap | | Ethanol | |
|---|---|---|---|---|---|---|---|---|
| | | 26 | | 26 | | 26 | | 26 |
| Sample | 1 hr | hrs | 1 hr | hrs | 1 hr | hrs | 1 hr | hrs |
| A | 4 | 3 | 4++ | 4+ | 4++ | 4+ | 4 | 4 |
| B | 4+ | 0 | 5 | 0 | 4++ | 0 | 5 | 0 |

### Example 7

### Comparison of a UV Cured Glycerol/Maleic Acid/Sebacic Acid Prepolymer with Flatting Agent and No Diluent to an AKZO NOBEL Acrylic-Urethane Cabinet Top Coat

Sample of a glycerol/maleic acid/sebacic acid prepolymer were prepared by the following method. 31.1 g. of glycerol, 45.2 g. maleic acid and 16.6 g of sebacic acid were placed in a 600 mL beaker. The beaker was immersed in a 200° C. oil bath while stirring the reaction mixture at 70 RPM using a 6 cm, football shaped, perforated metal agitator blade. After 20 min, the oil bath temperature was reduced to 160° C. and stirring continued for 30 min. The —OH group conversion, as measured by weight loss of water, was 82%. One sample (Sample A) was mixed with 34.7% acetone, 10% DAROCURE 1173 and 2.7% TEGO 410 and 1% BERMASILK flatting agent. A second sample (Sample B) was prepared as in sample A except that the acetone content was 49.3% and the BERMASILK content was 6%. The mixtures were rolled on to Leneta charts using a #15 wire wound rod for curing and were cured using UV radiation. An Akzo Nobel acrylic-urethane kitchen cabinet top coat was used as a comparison. The radiation source was located 5 centimeters from the final product and the mixture was cured for 3 minutes. The resulting film was dry to touch after 1 minute and fully cured after 3 minutes. After curing, Sample A was still glossy and very clear, and exhibited good resistance to water, acetone and soap. Sample B had almost the same gloss as the Akzo Nobel acrylic urethane control, but was much clearer. The results are summarized in Table 7.

TABLE 7
Solvent Resistance of Final Cured Polymer And Control

| | Acetone | | Water | | Soap | | Ethanol | |
|---|---|---|---|---|---|---|---|---|
| | | 26 | | 26 | | 26 | | 26 |
| Sample | 1 hr | hrs | 1 hr | hrs | 1 hr | hrs | 1 hr | hrs |
| A | 0 | 0 | 5 | N.A. | 4 | N.A. | 4 | N.A. |
| B | 0 | N.A. | 5 | 5 | 5 | 5 | 4+ | 3+ |
| Control | 4 | 3 | 5 | 5 | 4 | 4+ | 4++ | 4 |

### Example 8

### UV Cure of a Glycerol/Maleic Acid/Citric Acid Prepolymer With No Diluent

Three samples of a glycerolimaleic acid/sebacic acid prepolymer were prepared by the following method. 30.8 g. of glycerol, 43.6 g. maleic acid and 16.2 g of citric acid were placed in a 600 mL beaker. The beaker was immersed in a 200° C. oil bath while stirring the reaction mixture at 70 RPM using a 6 cm, football shaped, perforated metal agitator blade for 25 min. —OH conversion, as indicated by weight loss, was 100%. Resins using the samples were prepared as described in Table 8.

TABLE 8
Resin Mixtures Using A Glycerol/Maleic
Acid/Citric Acid Prepolymer

| Sample | Solvent (acetone) | DAROCURE 1173 | TEGO 410 |
|---|---|---|---|
| A | 70% | 10% | 0% |
| B | 69% | 6% | 0% |
| C | 70% | 10% | 2% |

The mixtures were rolled on to Leneta charts using a #15 wire wound rod and cured using UV radiation. The radiation source was located 5 centimeters from the final product and the mixture was cured for 3 minutes. The resulting film was dry to touch after 1 minute and fully cured after 3 minutes. After UV curing, the polymer film had a glossy appearance and good scratch resistance and, at low reaction time (sample A), exhibited good resistance to water, acetone soapy water and ethanol. The results are summarized in Table 9.

TABLE 9
Solvent Resistance of Final Cured Polymer

| | Acetone | | Water | | Soap | | Ethanol | |
|---|---|---|---|---|---|---|---|---|
| | | 26 | | 26 | | 26 | | 26 |
| Sample | 1 hr | hrs | 1 hr | hrs | 1 hr | hrs | 1 hr | hrs |
| A | 4 | 2 | 5 | 5 | 5 | 5 | 5 | 5 |
| B | 4 | 0 | 5 | 5 | 5 | 5 | 4+ | 4 |
| C | 4− | N.A. | 4 | N.A. | 4 | N.A. | 4− | N.A. |

### Example 9

### UV Cure of a Glycerol/Maleic Anydride/Citric Acid Prepolymer with No Diluent

A sample of glycerolimaleic anhydride/citric acid prepolymer was prepared by the following method. 31.4 g. of glycerol, 37.5 g. maleic anhydride and 16.0 g of citric acid were placed in a 600 mL beaker. The beaker was immersed in a 160° C. oil bath while stirring the reaction mixture at 70 RPM using a 6 cm, football shaped, perforated metal agitator blade. Two small samples were removed from the reactor after 40 minutes while the rest of the mixture was allowed to react for 60 min. Samples for UV cure testing were then prepared as described in Table 10.

TABLE 10
Preparation of Samples for UV Curing

| | Reaction | Solvent | Darocure 1173 | TEGO 410 |
|---|---|---|---|---|
| | Time | (weight % | (weight % | (weight % |
| SAMPLE | (min) | of resin) | of resin) | of resin) |
| A | 40 | 100% Acetone | 10% | 2% |
| B | 40 | 100% water | 10% | 2% |
| C | 60 | 100% acetone | 10% | 2% |
| D | 60 | 50% acetone | 10% | 2% |
| E | 60 | 100% water | 10% | 2% |

The mixtures were rolled on to Leneta charts using a #15 wire wound rod and cured using UV radiation. The radiation source was located 5 centimeters from the final product and was cured for 3 minutes. The resulting films were dry to touch after 1 minute and fully cured after 3 minutes. After UV curing, the polymer films had a glossy appearance and exhibited good resistance to water and soapy water, as described in Table 11.

TABLE 11
Solvent Resistance of Final Cured Polymer

| | Acetone | | | | Water | | Soap | | Ethanol | |
|---|---|---|---|---|---|---|---|---|---|---|
| Sample | 5 min | 15 min | 1 hr | 24 hrs | 1 hr | 24 hrs | 1 hr | 24 hrs | 1 hr | 24 hrs |
| A | 3 | 2+ | N.A. | N.A | 4++ | 3+ | 5 | 3+ | 4 | 3 |
| B | 3+ | 3 | 3 | 1 | 3 | 2 | 4 | 0 | 3 | 3 |
| C | 3− | 2 | N.A. | N.A | 4++ | 4 | 4+ | 5 | 4 | 3+ |
| D | 3+ | 2 | N.A. | N.A | 4+ | 4+ | 4+ | 5 | 4 | 3+ |
| E | 3+ | 3 | 2+ | 3+ | 4+ | 4 | 4+ | 4 | 3++ | 3+ |

### Example 10

### UV Cure of a Glycerol/Maleic Anhydride/Sebacic Acid Prepolymer with No Diluent

A sample of glycerol/maleic anhydride/sebacic acid prepolymer was prepared by the following method. 30.9 g. of glycerol, 39.9 g. maleic anhydride and 19.84 g sebacic acid were placed in a 600 mL beaker. The beaker was immersed in a 160° C. oil bath while stirring the reaction mixture at 70 RPM using a 6 cm, football shaped, perforated metal agitator blade. After 40 min, the oil bath was gradually heated to 200° C. over a period of 20 min, at which point the beaker was removed from the oil bath. Three samples were then prepared as described in Table 12.

TABLE 12
Preparation of Samples for UV Curing

| | Reaction | Solvent | DAROCURE 1173 | TEGO 410 |
|---|---|---|---|---|
| | Time | (weight % | (weight % | (weight % |
| Sample | (min) | of resin) | of resin) | of resin) |
| A | 60 | 100% acetone | 10% | 2% |
| B | 60 | 50% acetone | 10% | 2% |
| C | 60 | 100% water | 10% | 2% |

The mixtures were rolled on to Leneta charts using a #15 wire wound rod and cured using UV radiation. The radiation source was located 5 centimeters from the final product and the mixture was cured for 3 minutes. The resulting films were dry to touch after 1 minute and fully cured after 3 minutes. After UV curing, the polymer films had a glossy appearance and exhibited good resistance to water and soapy water, as described in Table 13.

TABLE 13
Solvent Resistance of Final Cured Polymer

| | Acetone | | | | Water | | Soap | | Ethanol | |
|---|---|---|---|---|---|---|---|---|---|---|
| Sample | 5 min | 15 min | 1 hr | 24 hrs | 1 hr | 24 hrs | 1 hr | 24 hrs | 1 hr | 24 hrs |
| A | 3+ | 2− | N.A. | N.A. | 4++ | 4 | 4 | 3+ | 4+ | 2 |
| B | 1+ | 1 | N.A | N.A | 5 | 4 | 4++ | 3+ | 4+ | 1 |
| C | 2 | 2− | N.A | N.A | 4++ | 3 | 4++ | 3 | 3 | 3 |

### Example 11

### UV Cure of a Glycerol/Maleic Acid/Sebacic Acid Prepolymer with No Diluent

Samples of glycerol/maleic acid/sebacic acid prepolymer were prepared by the following method. 31.1 g. of glycerol, 45.2 g. maleic acid and 16.6 g of sebacic acid were placed in a 600 mL beaker. The beaker was immersed in a 200° C. oil bath while stirring the reaction mixture at 70 RPM using a 6 cm, football shaped, perforated metal agitator blade. After 20 min, the oil bath temperature was lowered to 160° C. and stirring continued for an additional 30 min. The —OH group conversion, as measured by weight loss of water, was 82%. One sample (Sample A) was mixed with 25% acetone and 10% DAROCURE 1173. A second sample (Sample B) was mixed with 34% acetone and 10% DAROCURE 1173. The mixtures were rolled on to Leneta charts using a #15 wire wound rod for curing and were cured using UV radiation. The radiation source was located 5 centimeters from the final product and the mixture was cured for 3 minutes. The resulting films were dry to touch after 1 minute and fully cured after 3 minutes. After UV curing, polymer A and B were very glossy and very clear. Samples A and B exhibited good resistance to water and soapy water, but had poor resistance to acetone, as described in Table 14.

TABLE 14
Solvent Resistance of Final Cured Polymer

| | Acetone Spot Resistance | | | Water Spot Resistance | | | Soapy Water Resistance | | |
|---|---|---|---|---|---|---|---|---|---|
| Sample | 5 min. | 15 min. | 1 hr. | 15 min. | 1 hr. | 24 hrs. | 15 min. | 1 hr. | 24 hrs. |
| A | 1, blisters | N.A. | N.A. | 4 | 4 | 4 | 4 | 4 | 3 |
| B | 1, blisters | N.A. | N.A. | 5 | 4 | 5 | 4 | 4 | 4 |

### Example 12

### Preparation of a Castor Oil/Maleic Anhydride Polyester

Samples of a caster oil/maleic anhydride polyester were prepared by the following method. 173.06 g C.O. (0.186 mole, 0.56 eq —OH) and 26.64 g maleic anhydride (0.27 mole, 0.54 eq. —COOH) were placed in a beaker. The beaker was immersed in a 160° C. oil bath with stirring (198 RPM) for 95 minutes. During the immersion the reaction medium temperature rose from 135° C. to 150° C. The reaction medium was weighed before and after immersion in the oil bath and a weight loss of 5.7 g (0.31 eq. water) was observed. This weight loss, with the 0.27 eq anhydride groups equals 0.58 eq, indicating total conversion of the castor oil —OH groups.

The viscosity vs. temperature profile of the resulting polyester was measured as described in Table 15

TABLE 15
Viscosity vs. Temperature Profile of Final Polymer

| Temperature (° C.) | Viscosity (cps) |
|---|---|
| 102 | 50 |
| 79 | 100 |
| 71 | 150 |
| 62 | 225 |
| 51 | 350 |
| 45 | 625 |
| 39 | 900 |
| 23 | 3050 |

### Example 13

### UV Cure of a Castor Oil/Maleic Anhydride Polyester Mixture

A mixture was prepared by mixing 6 g. of the polyester as prepared in example 12, 4 g. of SR-454 monomer, 1 g. of Darocur 1173 and 0.22 g of Tego 410. The mixture was rolled on to a Leneta chart using a #15 wire wound rod for curing and were cured using UV radiation. The radiation source was located 5 centimeters from the final product and the mixture was cured using six passes of a 250 Watt mercury UV lamp. The resulting coating was glossy and non-tacky.)

### Example 14

### Preparation of a Glycerol/Castor Oil/Sebacic Acid/Maleic Anhydride Polyester

Samples of a caster oil/maleic anhydride polyester were prepared by the following method. 150 g. of castor oil (0.16 mole, 0.48 eq. —OH), 44.23 g. of glycerol (0.48 mole, 1.44 eq —OH) and 32.12 g. sebacid acid (0.16 mole, 0.32 eq —COOH) were placed in a beaker. The beaker was placed in a 160° C. oil bath and stirred. When the beaker was placed in the oil bath, the reaction mixture temperature was 110° C. After 15 minutes in the oil bath, the reaction mixture temperature rose to 150° C. and was held at 150° C. for an additional 70 min. The reaction medium was weighed before and after immersion in the oil bath and the weight loss over that period of time was 3.5 g. or 0.19 eq water. After weighing the reaction mixture, the beaker was returned to the oil bath and 73.02 g. of maleic anhydride (0.75 mole, 1.49 eq. —COOH) was added. The reaction mixture temperature was held between 130° C. and 155° C.) for 10 minutes. At the end of the 10 minute period, the reacture mixture was again weighed and the weight loss over that period of time was 1.8 g 0.1 eq. water. The total weight loss corresponds to 64% conversion of the —OH groups in the system.

The viscosity vs. temperature profile of the resulting polyester was measured as described in Table 15.

TABLE 15
Viscosity vs. Temperature Profile of Final Polymer

| Temperature (° C.) | Viscosity (cps) |
|---|---|
| 77 | 100 |
| 70 | 280 |
| 65 | 360 |
| 60 | 700 |
| 50 | 820 |
| 40 | 2920 |
| 32 | 4700 |
| 27 | 192000 |

### Example 15

### UV Cure of a Glycerol/Castor Oil/Sebacic Acid/Maleic Anhydride Polyester Mixture

A mixture was prepared by mixing 2.2 g. of a polyester as prepared in Example 14, 7.8 g. of SR-454 monomer, 1 g. of Darocur 1173 and 0.22 g of Tego 410. The mixture was rolled on to a Leneta chart using a #15 wire wound rod for curing and was cured using UV radiation. The radiation source was located 5 centimeters from the final product and the mixture was cured using six passes of a 250 Watt mercury UV lamp. The resulting coating was very hard and glossy after polishing.

### Example 16

### Dual (UV/Thermal) Cure of a Glycerol/Fumaric Acid/Citric Acid Copolymer

A glycerol/fumaric acid/citric acid copolymer was prepared as follows: 47.22 g. of glycerol and 44.41 g. of fumaric acid were placed in a beaker. The beaker was immersed in a 200° C. oil bath and stirred for 35 minutes. During the experiment, the reaction medium temperature increased from 115° C. to 150° C. Once the reaction mixture temperature reached 160° C., the oil bath temperature was decreased to 160° C. and 48 g. of citric acid were added to the reaction mixture. The reaction mixture was immersed in the 160° C. oil bath, with stirring, for 40 min. The beaker was then removed from the oil bath and allowed to cool. The reaction mixture was weighed before and after reaction and the overall weight loss indicated an overall rate of conversion of —OH groups of 39%.

After the copolymer was cooled to room temperature, a 1:1 polymer/ethanol solution was created by mixing equal molar parts of the polyester and ethanol. The resulting solution was placed on four pieces of Teflon sheet and allowed to evaporate to constant weight at room temperature. The samples were cured using UV radiation. The radiation source was located 5 centimeters from the final product and the mixture was cured a 36 W mercury UV lamp box for 0 minutes, 5 minutes, 15 minutes and 30 minutes, respectively. All four samples were then cured in a 200° C. oven for 15 minutes. The characteristics of the resulting samples are described in Table 16.

TABLE 16
Characteristics of Dual Cured Polyester

| UV Cure | |
|---|---|
| Time (min.) | Characteristics |
| 0 | Clear, somewhat tacky foam with small cells |
| 5 | Non-tacky, clear flexible foam with large cells |
| 15 | Non-tacky flexible film with small bubbles |
| 30 | Somewhat flexible polyester slab with very few bubbles |

### Example 17

### Dual (UV/Thermal) Cure of a Glycerol/Sebacic Acid/Maleic Anhydride Polyester

A glycerol/sebacic acid/maleic anhydride polyester was prepared as follows: 92 g. of glycerol and 51 g. of sebacic acid were placed in a beaker. The beaker was immersed in a 160° C. bath and stirred for 60 minutes. After 60 minutes, 114 g. maleic anhydred were added to the beaker. The reaction mixture was immersed in the oil bath for 10 minutes. The beaker was then removed from the oil bath and allowed to cool.

After the above polymer was cooled to room temperature, a mixture consisting of 34.6 g. of the prepared polymer, 30.7 g. Sr-454, 6.6 g. Darocur 1173 and 1.31 g. Tego 410 was prepared. The mixture was drawn on a glass slide using a 15 mil. drawdown bar and was cured using UV radiation. The radiation source was located 5 centimeters from the final product and the mixture was cured for 2 minutes using a 36 W mercury UV lamp box. The film was lifted from the glass and was slightly tacky and easy to tear. The film was then placed on a Teflon sheet and cured for 15 minutes in an oven at 200° C. The resulting film was less easily torn and much stronger.

### Example 18

### Preparation and UV Cure of an Acrylated Unsaturated Polyester Resin

A sample of an acrylated unsaturated polyester resin was prepared as follows: 24.42 g. of unsaturated polyester as prepared in Example 17 was dissolved in 63 g. of THF. After the unsaturated polyester was fully dissolved, 20 g. anhydrous magnesium sulfate were added to the mixture and the mixture allowed to stand, undisturbed, for approximately 12 hours. The mixture was then filtered into a 250 mL round bottom flask and 6 g. of triethylamine were added. The mixture was stirred in an ice bath for 15 minutes. 5 g. of acryloyl chloride were then added over a period of ten minutes and once addition was complete, the flask was removed from the ice bath. The mixture was stirred for an additional 2 hours and filtered.

10 g. of the mixture was placed in a flask with 0.3 g. Darocur 1173 and 0.2 g. Tego 410. The mixture was stirred with a hand-held spatula for 1 minute. The mixture was rolled on to a Leneta chart using a #3 wire wound rod for curing and was allowed to air dry at room temperature for 10 minutes. After 10 minutes, the mixture was cured using UV radiation. The radiation source was located 5 centimeters from the final product and the mixture was cured for 15 minutes using a 36 W mercury UV lamp. After curing, the resin coating was completely dry to touch.

### Example 19

### Preparation and UV Cure of an Unsaturated Polyester Aqueous Suspension

A sample of an unsaturated polyester aqueous suspension was prepared as follows: 2 g. of 0.0007 micron fumed silica were added to 100 mL of distilled water at 50° C. and homogenized at 50% power using a POLYTRON PCU-2-110 homogenizer. While the mixture was homogenizing, 20 ml of the unsaturated resin as prepared in Example 18 was preheated to 50° C. After the mixture was fully homogenized, the resin was added over a period of 4 minutes by syringe. The mixture was allowed to homogenize for 2 minutes at which time 0.28 g. sorbitan monopalmitate and 0.54 g of polyethylene glycol sorbitan monostearate were added. After the addition, the mixture was allowed to homogenize for 2 minutes. The homogenization produced a stable, milky white dispersion.

7 g. of the dispersion was mixed with 0.2 g. of Darocur 1173. The mixture was shaken by hand for 1 minute. The mixture was rolled on to a Leneta chart using a #3 wire wound rod for curing and was allowed to air dry at room temperature for 10 minutes. After 10 minutes, the mixture was cured using UV radiation. The radiation source was located 5 centimeters from the final product and the mixture was cured for 15 minutes using a 36 W mercury UV lamp. After curing, the polymer resin was almost completely tack-free.

1. A UV cured, crosslinked polycondensation product of
(a) one or more polyols selected from the group consisting of: (1) polyols with three or more hydroxyl groups, (2) acetal forms of (l), and (3) mixtures thereof, and
(b) one or more polyacids selected from the group consisting of: (1) polyacids with two or more carboxylic groups, (2) anhydrides of (1), (3) esters of (1), and (4) mixtures thereof, wherein at least one of the polyacids is unsaturated;
in which the molar ratio of polyol to polyacid is from about 1:3 to about 3:1; and the UV cured, crosslinked polycondensation product is highly-crosslinked, as evidenced by general insolubility in one or more solvents selected from the group consisting of: (1) water, (2) acetone, and (3) soap.

2. The UV cured, crosslinked polycondensation product of claim 1 wherein the one or more polyols are selected from the group consisting of: (1) linear (C1-C6) trihydroxy alkanes, (2) cyclic (C1-C6) trihydroxy alkanes, (3) linear (C2-C6) trihydroxy alkenes, (4) cyclic (C2-C6) trihydroxy alkenes, (5) acetal forms of (I)-(4), and (6) mixtures thereof.

3. The UV cured, crosslinked polycondensation product of claim 1 wherein the one or more polyacids are selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof, and wherein at least one of the polyacids is unsaturated.

4. The UV cured, crosslinked polycondensation product of claim 1 wherein the polyol is glycerol, castor oil or any combination thereof and the polyacid is selected from (1) maleic acid or its anhydride, (2) sebacic acid, (3) fumaric acid, (4) citric acid, (5) succinic acid, (6) anhydride forms of (1)-(5), (7) ester forms of (1)-(5), and (8) mixtures thereof.

5. The UV cured, crosslinked polycondensation product of claim 4 further containing a (1) acryloyl chloride, (2) methacryloyl chloride, (3) glycidyl methacrylate, (4) glycidyl acrylate, (5) methacrylic acid, (6) acrylic acid, or (7) mixtures thereof; wherein the UV cured, crosslinked polycondensation production contains at least one pendant double bond; and wherein the UV cured, crosslinked polycondensation product is highly-crosslinked, as evidenced by general insolubility in one or more solvents selected from the group consisting of: (1) water, (2) acetone, and (3) soap

6. A method for preparing a UV cured, crosslinked polycondensation product comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated;
(b) reacting the first mixture at a pressure at or above about atmosphere and at a temperature from about 80° C. to about 250° C. for a period of time from about 15 minutes to about 300 minutes to form a flowable low molecular weight prepolymer;
(c) mixing the flowable low molecular weight prepolymer with a photoinitiator to form a second mixture;
(d) optionally mixing the second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof, to form a third mixture;
(e) curing either (1) the second mixture or (2) the third mixture using ultraviolet radiation under conditions sufficient to produce a highly crosslinked polycondensation product.

7. A method of preparing a UV cured, crosslinked film or coating comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated;
(b) reacting the first mixture at a pressure at or above about 1 atmosphere and at a temperature from about 80° C. to about 250° C. for a period of time from about 15 minutes to about 300 minutes to form a flowable low molecular weight prepolymer;
(c) mixing the flowable low molecular weight prepolymer with a photoinitiator to form a second mixture;
(d) cooling the resulting second mixture to ambient conditions;
(e) heating the cooled second mixture to a temperature above the gel point of the second mixture until the second mixture is flowable;
(f) optionally mixing the flowable second mixture with a modification compound selected from the group consisting of: (1) polymer additives, (2) plasticizers, (3) foam blowing agents, (4) diluents, (5) other polymeric materials, (6) radically polymerizable monomers, and (7) mixtures thereof to form a polymer mixture; and
(g) applying either (1) the flowable second mixture or (2) the polymer mixture to a surface and curing by using ultraviolet radiation under conditions sufficient to produce a highly crosslinked film or coating.

8. A method of preparing a stabilized small prepolymer form comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated;
(b) reacting the first mixture at a pressure at or above about 1 atmosphere and at a temperature from about 80° C. to about 250° C. for a period of time from about 15 minutes to about 300 minutes to form a flowable low molecular weight prepolymer;
(c) mixing the flowable low molecular weight prepolymer with a photoinitiator to form a second mixture; and
(d) processing the second mixture into a small prepolymer form that is small and may easily be moved by a pneumatic or other transport system; and
(e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form.

9. A method for preparing a UV cured, crosslinked polycondensation product comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated;
(b) reacting the first mixture at a pressure at or above about 1 atmosphere and at a temperature from about 80° C. to about 250° C. for a period of time from about 15 minutes to about 300 minutes to form a flowable low molecular weight prepolymer;
(c) mixing the flowable low molecular weight prepolymer with a photoinitiator to form a second mixture;
(d) processing the second mixture into a small prepolymer form that is small and may easily be moved by a pneumatic or other transport system;
(e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form;
(f) cooling the stabilized small prepolymer form to ambient conditions;
(g) heating the stabilized small prepolymer form so that it flowable;
(h) optionally mixing the flowable stabilized small prepolymer form with a modification compound selected from the group consisting of: (1) polymer additives, (2) plasticizers, (3) foam blowing agents, (4) diluents, and (5) mixtures thereof, to form a third mixture;
(i) curing either (1) flowable stabilized small prepolymer form or (2) the third mixture either by (1) using ultraviolet radiation under conditions sufficient to produce a highly crosslinked polycondensation product, or by (2) heating at a pressure at or above about one (1) atmosphere and at a temperature from about 175° C. to about 400° C. for a period of time from about 3 seconds to about 60 minutes to form a highly crosslinked polycondensation product.

10. A method for preparing a UV cured, crosslinked film or coating comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1 and at least one of the polyacids is unsaturated;
(b) reacting the first mixture at a pressure at or above about 1 atmosphere and at a temperature from about 80° C. to about 250° C. for a period of time from about 15 minutes to about 300 minutes to form a low molecular weight prepolymer;
(c) mixing the flowable low molecular weight prepolymer with a photoinitiator to form a second mixture;
(d) processing the second mixture into a small prepolymer form that is small and may easily be moved by a pneumatic or other transport system;
(e) curing the surface of the small prepolymer form before, during, or after processing the second mixture into the small prepolymer form by applying ultraviolet radiation under conditions sufficient to produce crosslinking on the surface of the form without complete crosslinking of the entire form and thereby forming the stabilized small prepolymer form;
(f) cooling the stabilized small prepolymer form to ambient conditions;
(g) heating the stabilized small prepolymer form so that it flowable;
(h) optionally mixing the flowable stabilized small prepolymer form with a modification compound selected from the group consisting of: (1) polymer additives, (2) plasticizers, (3) foam blowing agents, (4) diluents, and (5) mixtures thereof to form a polymer mixture; and
(i) applying either (1) the flowable stabilized small prepolymer form or (2) the polymer mixture to a surface and curing either by (1) using ultraviolet radiation under conditions sufficient to produce a highly crosslinked film or coating, or by (2) heating at a pressure at or above about one (1) atmosphere and at a temperature from about 175° C. to about 400° C. for a period of time from about 3 seconds to about 60 minutes to form a highly crosslinked film or coating.

11. The method of claim 6, wherein the polyol is glycerol, castor oil or any combination thereof and the polyacid is selected from the group consisting of: (1) fumaric acid, (2) maleic acid or anhydride, (3) sebacic acid, (4) citric acid, and (5) mixtures thereof.

12. The UV cured, crosslinked polycondensation product of claim 2, wherein the one or more polyacids are selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof, and wherein at least one of the polyacids is unsaturated.

13. The UV cured, crosslinked polycondensation product of claim 2, wherein the polyol is glycerol, castor oil or any combination thereof and the polyacid is selected from (1) maleic acid or its anhydride, (2) sebacic acid, (3) fumaric acid, (4) citric acid, (5) succinic acid, (6) anhydride forms of (1)-(5), (7) ester forms of (1)-(5), and (8) mixtures thereof.

14. The UV cured, crosslinked polycondensation product of claim 3, wherein the polyol is glycerol, castor oil or any combination thereof and the polyacid is selected from (1) maleic acid or its anhydride, (2) sebacic acid, (3) fumaric acid, (4) citric acid, (5) succinic acid, (6) anhydride forms of (1)-(5), (7) ester forms of (1)-(5), and (8) mixtures thereof.

15. The method of claim 7, wherein the polyol is glycerol, castor oil or any combination thereof and the polyacid is selected from the group consisting of: (1) fumaric acid, (2) maleic acid or anhydride, (3) sebacic acid, (4) citric acid, and (5) mixtures thereof.

16. The method of claim 8, wherein the polyol is glycerol, castor oil or any combination thereof and the polyacid is selected from the group consisting of: (1) fumaric acid, (2) maleic acid or anhydride, (3) sebacic acid, (4) citric acid, and (5) mixtures thereof.

17. The method of claim 9, wherein the polyol is glycerol, castor oil or any combination thereof and the polyacid is selected from the group consisting of: (1) fumaric acid, (2) maleic acid or anhydride, (3) sebacic acid, (4) citric acid, and (5) mixtures thereof.

18. The method of claim 10, wherein the polyol is glycerol, castor oil or any combination thereof and the polyacid is selected from the group consisting of: (1) fumaric acid, (2) maleic acid or anhydride, (3) sebacic acid, (4) citric acid, and (5) mixtures thereof.
